(19) United States
(12) Patent Application Publication
(10) Pub. No.: US 2025/0231125 A1
(43) Pub. Date: Jul. 17, 2025

(54) METHOD FOR CALCULATING BATTERY CAPACITY CHARACTERISTICS

(71) Applicant: LG ENERGY SOLUTION, LTD., Seoul (KR)

(72) Inventors: Eun Ju LEE, Daejeon (KR); Kyun Il RAH, Daejeon (KR); Joonhyeon KANG, Daejeon (KR)

(21) Appl. No.: 18/839,407

(22) PCT Filed: Sep. 12, 2023
(86) PCT No.: PCT/KR2023/013610

§ 371 Date: Aug. 16, 2024

(30) Foreign Application Priority Data
Sep. 16, 2022 (KR) 10-2022-0116792

(51) Int. Cl. G01N 23/20; H01M 4/02; H01M 4/48; H01M 4/583

(52) U.S. Cl. CPC G01N 23/20; H01M 4/483; H01M 4/583; H01M 2004/027

(57) ABSTRACT

The present invention relates to a method for calculating battery capacity characteristics, the method including: a negative electrode preparation step for preparing a negative electrode in which graphite and a SiO-based material to be tested are mixed; a charging step for charging a battery including the negative electrode; a data collection step for observing the negative electrode using XRD and thereby collecting time series data for CLi which is the peak value of Li, C6(t) which is the peak value of Li2C12, and C12(t) which is the peak value of LiC12; and a parameter calculation step for calculating parameter K, which is a parameter indicating the battery capacity characteristics, on the basis of the CLi, C6(t), and C12(t) when the time differential value for the C6(t) or the C12(t) is 0, and to a battery in which the value of parameter K is at least 12 times the weight fraction of the SiO-based material in the negative electrode.

### TECHNICAL FIELD

The present application claims the benefit of priority based on Korean Patent Application No. 10-2022-0116792 filed on Sep. 16, 2022, the entire disclosure of which is incorporated as a part of this specification.

The present disclosure relates to a method for calculating battery capacity characteristics, and more particularly, to a method for calculating battery capacity characteristics that calculates parameters relating to capacity characteristics of a battery equipped with an anode containing an SiO-based material.

### BACKGROUND ART

For a secondary battery, an energy density of the battery is the most important characteristic. High energy density can extend the usage time of portable devices and is expected to extend the driving range of electric vehicles.

Lithium-ion batteries have surpassed all other previously competing batteries (e.g., lead acid batteries, nickel hydride batteries, etc.), but higher energy densities are still required.

One of the developments in high energy density of batteries is increasing the capacity of an anode. High capacity of the anode may be achieved by using an anode in which graphite is mixed with silicon monoxide (SiO). However, silicon monoxide forms lithium silicate which is a lithium consumption product with little reactivity, and may be a material with a very large initial irreversible capacity.

Li₂C₁₂ [symbol] LiC₁₂+Li

4SiO+(4+3x)Li→Li₄SiO₄+3LiₓSi

In order to improve this, silicon monoxide (SiO) is chemically doped with materials such as lithium (Li) or magnesium (Mg) to increase efficiency at the material level.

However, since there is no standard for what characteristics highly efficient silicon monoxide has to ensure stable lifespan in a mixing application cell, a technology that can define this is needed.

### DISCLOSURE OF THE INVENTION

### Technical Goals

The present disclosure relates to a method for calculating battery capacity characteristics, and is to provide a method for calculating battery capacity characteristics that calculates parameters relating to capacity characteristics of a battery equipped with an anode containing an SiO-based material.

Technical objects to be achieved by the present disclosure are not limited to the technical objects mentioned above, and other technical objects that are not mentioned will be clearly understood by those skilled in the art from the description below.

### Technical Solutions

A method for calculating battery capacity characteristics of the present disclosure may include:
an anode preparation step of preparing an anode in which graphite is mixed with a test target SiO-based material;
a charging step of charging a battery including the anode;
a data collection step of collecting time series data for C_{Li} which is a peak of Li, C₆(t) which is a peak of Li₂C₁₂, and C₁₂(t) which is a peak of LiC₁₂ by observing the anode with XRD; and
a parameter calculation step of calculating K which is a parameter for battery capacity characteristics based on the C_{Li}, C₆(t), and C₁₂(t) values, when a time differential value for the C₆(t) or the C₁₂(t) is 0.

### Advantageous Effects

A method for calculating battery capacity characteristics of the present disclosure may be to select SiO-based materials by quantifying a reaction rate of graphite and SiO with Li.

The method for calculating battery capacity characteristics of the present disclosure may contribute to the design of long-life batteries and batteries with stable cycle performance by providing parameters representing battery capacity characteristics relating to an actual usage rate of SiO which has weak durability.

### BRIEF DESCRIPTION OF DRAWINGS

FIG. 1 is a block diagram illustrating a method for calculating battery capacity characteristics of the present disclosure.

FIG. 2 is a graph illustrating time series data for C₆(t) and C₁₂(t) of battery sample 1.

FIG. 3 is a graph illustrating structural changes of anodes of battery sample 1 (a) and battery sample 2 (b) over time.

FIG. 4 is a graph illustrating capacity retention according to cycle of battery sample 1 and battery sample 2.

### BEST MODE FOR CARRYING OUT THE INVENTION

A method for calculating battery capacity characteristics of the present disclosure may include:
an anode preparation step of preparing an anode in which graphite is mixed with a test target SiO-based material;
a charging step of charging a battery including the anode;
a data collection step of collecting time series data for C_{Li} which is a peak of Li, C₆(t) which is a peak of Li₂C₁₂, and C₁₂(t) which is a peak of LiC₁₂ by observing the anode with XRD; and
a parameter calculation step of calculating K which is a parameter for battery capacity characteristics based on the C_{Li}, C₆(t), and C₁₂(t) values, when a time differential value for the C₆(t) or the C₁₂(t) is 0.

In the anode preparation step of the method for calculating battery capacity characteristics of the present disclosure, the anode may be prepared so that a weight fraction of the test target SiO-based material in the anode is 0.15 or less.

In the anode preparation step of the method for calculating battery capacity characteristics of the present disclosure, the SiO-based material may be SiO doped with Li, Mg, or a mixture thereof.

In the charging step of the method for calculating battery capacity characteristics of the present disclosure, the battery may be fully charged so that a state of charge (SOC) becomes 100%.

In the data collection step of the method for calculating battery capacity characteristics of the present disclosure, the state of charge of the battery may be such that the SOC is maintained above 50%.

In the parameter calculation step of the method for calculating battery capacity characteristics of the present disclosure, K may be calculated by Equation 1 below:

$$K = \frac{{C}_{12} ( t ) \cdot {C}_{Li}}{{C}_{6} ( t )} \qquad [ Equation 1 ]$$

The method for calculating battery capacity characteristics of the present disclosure, may further include, after the parameter calculation step, a determination step of determining a capacity characteristic state of the battery by comparing the K value and a weight fraction value of the test target SiO-based material in the anode.

A battery equipped with an anode containing an SiO-based material of the present disclosure may include an anode containing graphite and SiO-based materials; an anode current collector on which the anode is applied; a cathode containing lithium; a cathode current collector on which the cathode is applied; a separator stacked between the anode and the cathode; an electrolyte solution impregnated into the cathode and the anode; and a case accommodating the anode, the cathode, the anode current collector, the cathode current collector, the separator, and the electrolyte solution therein, wherein the anode contains the SiO-based material doped with Li, Mg, or a mixture thereof, and the K value calculated by the method according to claim 6 is 12 times or more than a weight fraction of the SiO-based material in the anode.

### MODES FOR CARRYING OUT THE INVENTION

Hereinafter, embodiments according to the present disclosure will be described in detail with reference to the accompanying drawings. In this process, the size or shape of components shown in the drawings may be exaggerated for clarity and convenience of explanation. In addition, terms specifically defined in consideration of the configuration and operation of the present disclosure may vary according to the intentions or customs of users and operators. Definitions of these terms should be made based on the content throughout this specification.

In the description of the present disclosure, it should be noted that the orientation or positional relationship indicated by the terms such as “center”, “upper”, “lower”, “left”, “right”, “vertical”, “horizontal”, “inner side”, “outer side”, “one surface”, and “other surface” is based on the orientation or positional relationship shown in the drawing or the orientation or positional relationship normally arranged when using a product of the present disclosure, and it is not to be construed as limiting the present disclosures because it is intended merely for explanation and brief description of the present disclosure and does not suggest or imply that the device or element shown must necessarily be configured or operated in a specific orientation with a specific orientation.

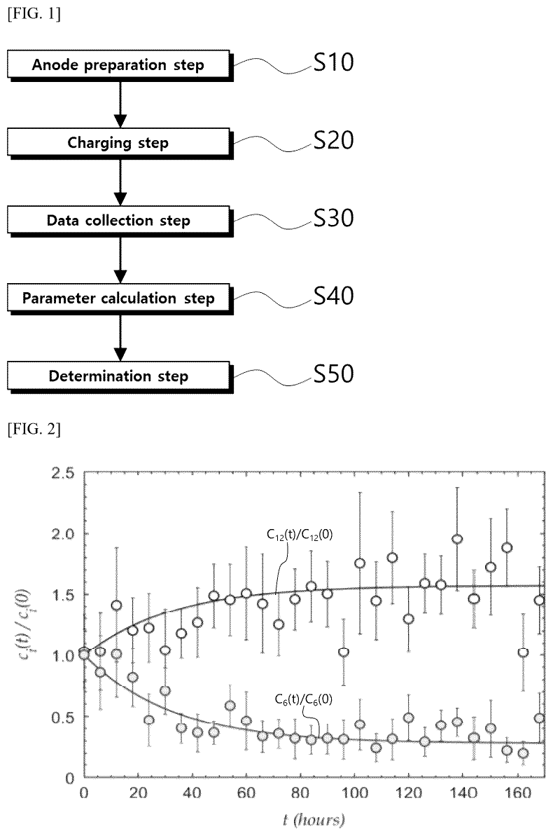

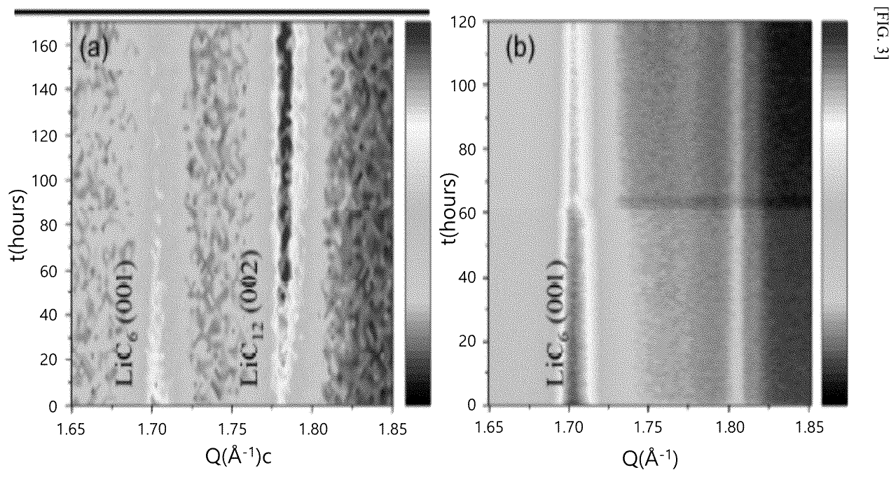

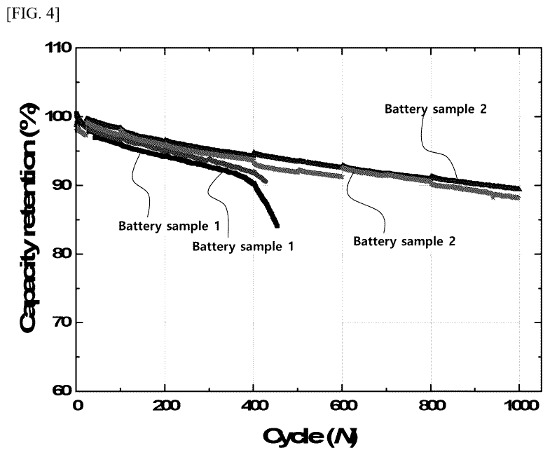

FIG. 1 is a block diagram illustrating a method for calculating battery capacity characteristics of the present disclosure. FIG. 2 is a graph illustrating time series data for C₆(t) and C₁₂(t) of battery sample 1. FIG. 3 is a graph illustrating structural changes of anodes of battery sample 1 and battery sample 2 over time. FIG. 4 is a graph illustrating capacity retention according to cycle of battery sample 1 and battery sample 2.

Hereinafter, referring to FIGS. 1 to 4, a method for calculating battery capacity characteristics of the present disclosure is described in detail.

As shown in FIG. 1, the method for calculating battery capacity characteristics of the present disclosure may include:
an anode preparation step (S10) of preparing an anode in which graphite is mixed with a test target SiO-based material;
a charging step (S20) of charging a battery including the anode;
a data collection step (S30) of collecting time series data for C_{Li} which is a peak of Li, C₆(t) which is a peak of Li₂C₁₂, and C₁₂(t) which is a peak of LiC₁₂ by observing the anode with XRD; and
a parameter calculation step (S40) of calculating K which is a parameter for battery capacity characteristics based on the C_{Li}, C₆(t), and C₁₂(t) values, when a time differential value for the C₆(t) or the C₁₂(t) is 0.

In the method for calculating battery capacity characteristics of the present disclosure, the analysis target is an anode containing an SiO-based material, specifically, a graphite-based material containing an SiO-based material, and more specifically, a graphite-based material containing SiO doped with Li, Mg, or the like.

In the anode preparation step (S10), the anode may be prepared so that a weight fraction of the test target SiO-based material in the anode is 0.15 or less. The weight fraction of the test target SiO-based material in the anode may be 0.01 or more, 0.03 or more, or 0.05 or more, and 0.15 or less, 0.12 or less, or 0.10 or less.

The method for calculating battery capacity characteristics of the present disclosure may provide parameters that can determine performance, such as the stability of battery life, which varies depending on the characteristics (doping material, degree of doping, etc.) of the SiO-based material contained in the anode, for example, the rate of change in capacity retention depending on the number of cycles.

The method for calculating battery capacity characteristics of the present disclosure may determine whether the test target SiO-based material can guarantee life stability for the battery by analyzing a battery equipped with an anode containing the test target SiO-based material. More specifically, the impact of SiO-based materials on battery life stability may be provided as a quantified parameter. For example, the method for calculating battery capacity characteristics of the present disclosure may be performed for a lithium secondary battery equipped with an anode containing a test target SiO-based material.

In the anode preparation step (S10), the SiO-based material may be SiO doped with Li, Mg, or a mixture thereof. The method for calculating battery capacity characteristics of the present disclosure may provide the degree of guarantee of battery life stability as a quantified parameter even for an SiO-based material whose doping state is unknown.

In the charging step (S20), the battery may be fully charged so that a state of charge (SOC) becomes 100%. When charging the lithium secondary battery, lithium ions move to the anode and may be reduced to lithium atoms at the anode. By analyzing the state at this time, the method for calculating battery capacity characteristics of the present disclosure may calculate the K.

In the data collection step (S30), the state of charge of the battery may be such that the SOC is maintained above 50%. In the data collection step (S30), most preferably, the XRD measurement is performed in a fully charged state, but depending on the analysis situation, the XRD measurement may be performed in a state of charge with the SOC maintained at 50% or more. During XRD measurement, the battery may be simply fixed to the XRD stage, or if self-discharge is fast, it may be mounted on the XRD stage with the charging module connected. XRD measurements may be performed in-situ to observe changes in the battery.

In the data collection step (S30), XRD measurements may be performed in set time units. The set time may be from 2 hours to 8 hours. Preferably, the set time may be 4 hours to 6 hours. For example, the set time may be about 4 hours. In other words, in the data collection step (S30), XRD measurement may be performed approximately every 4 hours. A battery equipped with an anode containing an SiO-based material may be stabilized in about 60 hours. Therefore, XRD measurements may be performed at set time intervals for a period of 40 hours to 100 hours. In other words, the XRD measurement may be performed repeatedly at set time intervals until the anode is stabilized.

The data collected in the data collection step (S30) may be fitted and calculated as a function of time t. Specifically, among the XRD measurement data, C₆(t) which is the peak of Li₂C₁₂ and C₁₂(t) which is the peak of LiC₁₂ may be fitted as a function.

In the parameter calculation step (S40), the K may be calculated based on the reversible reaction of the anode,

Li₂C₁₂ [symbol] LiC₁₂+Li
by Equation 1 below. In the present specification, Li₂C₁₂ may be expressed as LiC₆ for convenience, and in Equation 1 below, C₆ refers to the concentration of Li₂C₁₂, and C₁₂ refers to the concentration of LiC₁₂.

$$K = \frac{{C}_{12} ( t ) \cdot {C}_{Li}}{{C}_{6} ( t )} \qquad [ Equation 1 ]$$

In the parameter calculation step (S40), the values of C₆(t) and C₁₂(t) to which Equation 1 is applied may be values that converge to a specific value after sufficient time. Specifically, the values of C₆(t) and C₁₂(t) at t when the time differential values of C₆(t) and C₁₂(t) are O may be applied to Equation 1.

As shown in FIG. 1, after the parameter calculation step (S40), a determination step (S50) of determining a capacity characteristic state of the battery by comparing the K value and a weight fraction value of the test target SiO-based material in the anode may be further included. Specifically, it may be determined that the greater the value divided by the weight fraction value of the test target SiO-based material in the anode from the K value, the better the life stability of the battery (e.g., less decrease in capacity retention as the number of cycles increases). For example, when the K value divided by the weight fraction of the test target SiO-based material in the anode is 12 or more, 20 or more, 30 or more, or 40 or more, it can be determined that the life stability of the battery is secured.

A battery equipped with an anode containing an SiO-based material of the present disclosure may include:
an anode containing graphite and SiO-based materials;
an anode current collector on which the anode is applied;
a cathode containing lithium;
a cathode current collector on which the cathode is applied;
a separator stacked between the anode and the cathode;
an electrolyte solution impregnated into the cathode and the anode; and
a case accommodating the anode, the cathode, the anode current collector, the cathode current collector, the separator, and the electrolyte solution therein,
wherein the anode contains the SiO-based material doped with Li, Mg, or a mixture thereof, and
the K value calculated by the method for calculating battery capacity characteristics is 12 times or more, 20 times or more, 30 times or more, or 40 times or more than a weight fraction of the SiO-based material in the anode.

The anode may be a mixture of an anode active material, a conductive material and a binder. The anode active material may include graphite and SiO-based materials.

The cathode may be a mixture of a cathode active material, a conductive material and a binder. The cathode active material may include lithium.

For example, the anode current collector may be Cu foil, and the cathode current collector may be Al foil.

### EXAMPLE

Two types of SiO-based materials with unknown compositions were prepared, and two types of anodes were prepared to have a weight fraction of 0.1 for each SiO-based material, and a battery was manufactured for each anode to prepare battery sample 1 and battery sample 2.

Battery sample 1 and battery sample 2 were fully charged to a SOC of 100%, and then XRD measurements were performed every 4 hours at a temperature of 60° C. to collect data for each battery.

From the XRD measurement data for each of battery sample 1 and battery sample 2, C_{Li} which is the peak of Li, C₆(t) which is the peak of Li₂C₁₂, and C₁₂(t) which is the peak of LiC₁₂ were calculated, respectively.

For the calculated C_{Li}, C₆(t), and C₁₂(t), at the point where t is sufficiently large (the point where the differential value is 0), Equation 1 was applied to calculate the K value for each of battery sample 1 and battery sample 2. FIG. 2 is a graph illustrating time series data for C₆(t) and C₁₂(t) of battery sample 1. As shown in FIG. 2, K was calculated at a value where t is 100 or more, where C₆(t) and C₁₂(t) are parallel.

Battery sample 1 was calculated with a K value of 4.10, and battery sample 2 was calculated with a K value of 1.14.

FIG. 3 is a graph illustrating structural changes of anodes of battery sample 1 and battery sample 2 over time. In FIG. 3, (a) is a graph for battery sample 1, and (b) is a graph for battery sample 2. In FIG. 3, the color variable refers to the peak in the XRD measurement value, and if it is red, it may be a large peak, and if it is blue, it may be a small peak. Referring to FIG. 3, it can be seen that the change in LiC₆ over time in battery sample 2 (b) is slower than in battery sample 1 (a). This means that it reacts better with SiO, indicating that the lifespan characteristics of the electrode are not good.

FIG. 4 is a graph illustrating capacity retention according to cycle of battery sample 1 and battery sample 2. In FIG. 4, battery sample 1 and battery sample 2 are manufacture in pairs, and the results of charging and discharging each of them are shown.

As shown in FIG. 4, it can be seen that battery sample 1 which has a higher K value shows better capacity retention according to the number of cycles than battery sample 2.

Although embodiments according to the present disclosure have been described above, they are merely illustrative, and those skilled in the art will understand that various modifications and equivalent scope of embodiments are possible therefrom. Therefore, the true technical protection scope of the present disclosure should be determined by the appended claims.

### INDUSTRIAL APPLICABILITY

A method for calculating battery capacity characteristics of the present disclosure may be to select SiO-based materials by quantifying the reaction rate of graphite and SiO with Li.

The method for calculating battery capacity characteristics of the present disclosure may contribute to the design of long-life batteries and batteries with stable cycle performance by providing parameters representing battery capacity characteristics relating to the actual usage rate of SiO which has weak durability.

1. A method for calculating battery capacity characteristics, the method comprising:
charging a battery comprising the anode which comprises graphite and an SiO-based material;
collecting time series data for C₆(t) which is a peak of Li₂C₁₂, and C₁₂(t) which is a peak of LiC₁₂ by observing the anode with X-Ray Diffraction (XRD) and obtaining C_{Li} which is a peak of Li; and
calculating a value of K, which is a parameter for battery capacity characteristics, based on C_{Li}, C₆(t), and C₁₂(t), when a time differential value for the C₆(t) or the C₁₂(t) is 0.

2. The method of claim 1, wherein the anode is prepared such that a weight fraction of the SiO-based material in the anode is 0.15 or less.

3. The method of claim 1, wherein the SiO-based material is SiO doped with Li, Mg, or a mixture thereof.

4. The method of claim 1, wherein charging the battery comprises charging the battery to a 100% state-of-charge (SOC).

5. The method of claim 4, wherein, when collecting time series data, the SOC of the battery is maintained above 50%.

6. The method of claim 1, wherein the value of K is calculated according to an equation:
$$K = \frac{{C}_{12} ( t ) \cdot {C}_{Li}}{{C}_{6} ( t )} .$$

7. The method of claim 6, further comprising:
determining a capacity characteristic state of the battery by comparing the value of K and a weight fraction value of the SiO-based material in the anode.

8. A battery, comprising:
an anode comprising graphite and an SiO-based material;
an anode current collector on which the anode is applied;
a cathode containing lithium;
a cathode current collector on which the cathode is applied;
a separator between the anode and the cathode;
an electrolyte solution impregnated into the cathode and the anode; and
a case accommodating the anode, the cathode, the anode current collector, the cathode current collector, the separator, and the electrolyte solution therein,
wherein the SiO-based material is doped with Li, Mg, or a mixture thereof,
a value of K, which is a parameter for battery capacity characteristics, is 12 times or more than a weight fraction of the SiO-based material in the anode, and the value of K is measured according to an equation:
$$K = \frac{{C}_{12} ( t ) \cdot {C}_{Li}}{{C}_{6} ( t )} ,$$
and by
charging a battery comprising the anode;
collecting time series data for C_{Li} which is a peak of Li, C₆(t) which is a peak of Li₂C₁₂, and C₁₂(t) which is a peak of LiC₁₂ by observing the anode with X-Ray Diffraction (XRD); and
calculating the value of K, when a time differential value for the C₆(t) or the C₁₂(t) is 0.
